(19) United States
(12) Patent Application Publication
(10) Pub. No.: US 2026/0346061 A1
(43) Pub. Date: Nov. 5, 2026

(54) FALL PROTECTION SYSTEM AND ASSOCIATED METHOD

(71) Applicant: Honeywell Safety Products USA, Inc., Charlotte, NC (US)

(72) Inventor: RONALD GIOVANY GIL GONZALEZ, Zapopan JAL (MX)

(21) Appl. No.: 19/078,555

(22) Filed: Mar. 13, 2025

(51) Int. Cl. A62B 35/00; B66F 11/04

(52) U.S. Cl. CPC A62B 35/0043; B66F 11/042

(57) ABSTRACT

A fall protection system is provided. For example, a fall protection system comprises an elongated rail and a shuttle. The rail comprises an elongated top flange, an elongated bottom flange, and an elongated web therebetween. The shuttle is selectively engaged with the rail and comprises a main body and an attachment point projecting upward from the main body. The shuttle is selectively movable along the rail when a force applied to the attachment point of the shuttle is greater than a first threshold and less than a second threshold. The shuttle pivots such that at least a portion of the main body of the shuttle binds up between the top flange and the bottom flange and the shuttle does not move when a force applied to the attachment point of the shuttle is greater than the second threshold.

### FIELD OF THE INVENTION

Embodiments of the present disclosure generally relate to fall protection systems, and, more particularly, to fall protection systems for elevated work platforms.

### BACKGROUND

A mobile elevated work platform (MEWP) is a machine that lifts people, tools, and materials to work at heights. MEWPs are used in construction, maintenance, and other industries. One common type of MEWP is called a scissor lift, which is named for its lifting mechanism which uses crisscrossed beams that move like a pair of scissors when raising or lowering a platform. A scissor lift typically comprises a base (which may be motorized to propel the lift to different work locations), the scissor-like lifting mechanism, and a work platform that can be raised up and down by the lifting mechanism. Other common types of MEWPs include boom lifts and telescopic masts.

According to safety regulations, workers on such MEWPs must use a fall protection system. Such fall protection systems typically comprise a harness worn by the worker. The harness is attached to an anchorage point using a lanyard. The anchorage point may be attached to the guardrail or the guardrail may function as the attachment point, including any suitable part of the guardrail (e.g., its vertical posts or its horizontal top beams).

Such conventional fall protection systems may still allow the worker to be ejected from the work platform. While such fall protection systems should arrest the worker's fall such that the worker does not fall to the floor, even such an arrested fall from a full ejection can result in injury (e.g., from the worker colliding with the lift mechanism).

Existing fall protection systems are plagued by technical challenges and limitations. Through applied effort, ingenuity, and innovation, many of these identified problems have been solved by developing solutions that are included in embodiments of the present disclosure, many examples of which are described in detail herein.

### BRIEF SUMMARY

Various embodiments described herein relate to fall protection systems and associated methods of fall protection.

A fall protection system is provided. For example, a fall protection system comprises an elongated rail adapted to be mounted to a surface, the rail comprising an elongated top flange, an elongated bottom flange substantially parallel to the top flange, and an elongated web therebetween that is substantially perpendicular to the top flange and the bottom flange; and a shuttle selectively engaged with the rail, the shuttle comprising a main body and an attachment point projecting upward from the main body, the attachment point adapted to have a connecting device directly or indirectly attached thereto. The shuttle is configured to be selectively movable along the rail in a first direction along a longitudinal axis of the rail when a force applied to the attachment point of the shuttle has a first direction component that is greater than a first threshold and less than a second threshold. The shuttle is configured to be selectively movable along the rail in a second direction along the longitudinal axis of the rail opposite the first direction when a force applied to the attachment point of the shuttle has a second direction component that is greater than the first threshold and less than the second threshold. The shuttle is configured to pivot in the first direction such that at least a portion of the main body of the shuttle binds up between the top flange of the rail and the bottom flange of the rail so that the shuttle does not move in the first direction when a force applied to the attachment point of the shuttle has a first direction component that is greater than the second threshold. The shuttle is configured to pivot in the second direction such that at least a portion of the main body of the shuttle binds up between the top flange of the rail and the bottom flange of the rail so that the shuttle does not move in the second direction when a force applied to the attachment point of the shuttle has a second direction component that is greater than the second threshold.

In some embodiments, the main body of the shuttle comprises a first main body portion and an opposing second main body portion, and the attachment point comprises an arch connecting the first main body portion and the second main body portion.

In some embodiments, when the shuttle is selectively engaged with the rail, at least a portion of the first main body portion is sandwiched between the top flange of the rail and the bottom flange of the rail on a first side of the web, at least a portion of the second main body portion is sandwiched between the top flange of the rail and the bottom flange of the rail on an opposing second side of the web, and the arch of the attachment point passes over the top flange of the rail.

In some embodiments, the first main body portion has a bottom surface that is generally convex such that opposing first and second end portions of the first main body portion are further away from the bottom flange of the rail than a center portion of the first main body portion when the shuttle is selectively engaged with the rail and not pivoted, and the second main body portion has a bottom surface that is generally convex such that opposing first and second end portions of the second main body portion are further away from the bottom flange of the rail than a center portion of the second main body portion when the shuttle is selectively engaged with the rail and not pivoted.

In some embodiments, the first main body portion comprises a first compressible member adjacent the first end portion of the first main body portion and projecting downward and in contact with the bottom flange of the rail when the shuttle is selectively engaged with the rail and not pivoted, and the first main body portion comprises a second compressible member adjacent the second end portion of the first main body portion and projecting downward and in contact with the bottom flange of the rail when the shuttle is selectively engaged with the rail and not pivoted, the second main body portion comprises a first compressible member adjacent the first end portion of the second main body portion and projecting downward and in contact with the bottom flange of the rail when the shuttle is selectively engaged with the rail and not pivoted, and the second main body portion comprises a second compressible member adjacent the second end portion of the second main body portion projecting downward and in contact with the bottom flange of the rail when the shuttle is selectively engaged with the rail and not pivoted. When the shuttle is selectively engaged with the rail and not pivoted, only the first compressible member of the first main body portion, the second compressible member of the first main body portion, the first compressible member of the second main body portion, and the second compressible member of the second main body portion are in contact with the bottom flange of the rail.

In some embodiments, when a force applied to the attachment point of the shuttle has a first direction component that is greater than the second threshold, the first compressible member of the first main body portion at least partly compresses and the first compressible member of the second main body portion at least partly compresses such that the shuttle pivots in the first direction and at least a portion of the main body of the shuttle binds up between the top flange of the rail and the bottom flange of the rail. When a force applied to the attachment point of the shuttle has a second direction component that is greater than the second threshold, the second compressible member of the first main body portion at least partly compresses and the second compressible member of the second main body portion at least partly compresses such that the shuttle pivots in the second direction and at least a portion of the main body of the shuttle binds up between the top flange of the rail and the bottom flange of the rail.

In some embodiments, the first compressible member of the first main body portion, the second compressible member of the first main body portion, the first compressible member of the second main body portion, and the second compressible member of the second main body portion each comprise a collapsible stem with a proximal end attached to or integral with the respective main body portion and a distal end that is in contact with the bottom flange of the rail when the shuttle is selectively engaged with the rail and not pivoted.

In some embodiments, the collapsible stem of the first compressible member of the first main body portion, the second compressible member of the first main body portion, the first compressible member of the second main body portion, and the second compressible member of the second main body portion each have a zig-zag shape.

In some embodiments, when a force is applied to the attachment point of the shuttle that has a first direction component that is greater than the second threshold, the first compressible member of the first main body portion and the first compressible member of the second main body portion both at least partly compress to allow the shuttle to pivot in the first direction. When a force is applied to the attachment point of the shuttle that has a second direction component that is greater than the second threshold, the second compressible member of the first main body portion and the second compressible member of the second main body portion both at least partly compress to allow the shuttle to pivot in the second direction.

In some embodiments, the fall protection system further comprises a mat having a first portion on a first side of the rail and a second portion on a second side of the rail with the rail in a gap therebetween such that a top surface of the top flange of the rail is substantially even with a top surface of the first portion of the mat and a top surface of the second portion of the mat.

In accordance with various embodiments of the present disclosure, a method of fall protection is provided. In some embodiments, the method comprises mounting an elongated rail substantially horizontally to a surface, the rail comprising an elongated top flange, an elongated bottom flange substantially parallel to the top flange, and an elongated web therebetween that is substantially perpendicular to the top flange and the bottom flange; engaging a shuttle selectively with the rail, the shuttle comprising a main body and an attachment point projecting upward from the main body, the attachment point adapted to have a connecting device directly or indirectly attached thereto; and attaching a distal end of a connecting device to the attachment point of the shuttle, the connecting device having a proximal end attached to a harness worn by a user. The shuttle is configured to be selectively movable along the rail in a first direction along a longitudinal axis of the rail when the user applies a force to the attachment point of the shuttle has a first direction component that is greater than a first threshold and less than a second threshold. The shuttle is configured to be selectively movable along the rail in a second direction along the longitudinal axis of the rail opposite the first direction when the user applies a force to the attachment point of the shuttle has a second direction component that is greater than the first threshold and less than the second threshold. The shuttle is configured to pivot in the first direction such that at least a portion of the main body of the shuttle binds up between the top flange of the rail and the bottom flange of the rail so that the shuttle does not move in the first direction when the user applies a force to the attachment point of the shuttle has a first direction component that is greater than the second threshold. The shuttle is configured to pivot in the second direction such that at least a portion of the main body of the shuttle binds up between the top flange of the rail and the bottom flange of the rail so that the shuttle does not move in the second direction when the user applies a force to the attachment point of the shuttle has a second direction component that is greater than the second threshold.

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 is a perspective view of an example fall protection system installed and in use on a mobile elevated work platform, in accordance with example embodiments of the present disclosure;

FIG. 2 is a close up perspective view of a portion of an example rail of the example fall protection system of FIG. 1, in accordance with example embodiments of the present disclosure;

FIG. 3 is a perspective view of an example shuttle of the example fall protection system of FIG. 1, separated from the rail;

FIG. 4 is a sectional view of the example fall protection system of FIG. 1, in accordance with example embodiments of the present disclosure;

FIG. 5 is a side view of the example shuttle of FIG. 3; and

FIGS. 6A-C are side views of the example shuttle of FIG. 3 in different orientations during use, in accordance with example embodiments of the present disclosure.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” “bottom,” “left,” “right,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The phrases “in one example,” “according to one example,” “in some examples,” and the like generally mean that the particular feature, structure, or characteristic following the phrase may be included in at least one example of the present disclosure and may be included in more than one example of the present disclosure (importantly, such phrases do not necessarily refer to the same example).

If the specification states a component or feature “may,” “can,” “could,” “should,” “would,” “preferably,” “possibly,” “typically,” “optionally,” “for example,” “as an example,” “in some examples,” “often,” or “might” (or other such language) be included or have a characteristic, that specific component or feature is not required to be included or to have the characteristic. Such component or feature may be optionally included in some examples, or it may be excluded.

The word “example” or “exemplary” is used herein to mean “serving as an example, instance, or illustration.” Any implementation described herein as “example” or “exemplary” is not necessarily to be construed as preferred or advantageous over other implementations.

The term “electronically coupled,” “electronically coupling,” “electronically couple,” “in communication with,” “in electronic communication with,” or “connected” in the present disclosure refers to two or more elements or components being connected through wired means and/or wireless means, such that signals, electrical voltage/current, data and/or information may be transmitted to and/or received from these elements or components.

The term “component” may refer to an article, a device, or an apparatus that may comprise one or more surfaces, portions, layers and/or elements. For example, an example component may comprise one or more substrates that may provide underlying layer(s) for the component and may comprise one or more elements that may form part of and/or are disposed on top of the substrate. In the present disclosure, the term “element” may refer to an article, a device, or an apparatus that may provide one or more functionalities.

Various embodiments of the present disclosure overcome the above technical challenges and difficulties and provide various technical improvements and advantages. For example, various embodiments of the present disclosure provide example fall protection systems and example methods of fall protection.

In various embodiments of the present disclosure, a fall protection system allows a user to readily move back and forth within the work platform but, if the user begins to eject over, restrains the user such that the user cannot eject out of the work platform. In this regard, the fall protection system of embodiments of the present disclosure prevents complete ejections. In other words, the fall protection system of embodiments of the present disclosure achieves incomplete ejections. While embodiments of the present disclosure are described herein in relation to use with a MEWP, and specifically a scissor lift, various embodiments of the present disclosure can be used in any suitable MEWP (such as boom lifts and telescopic masts) and in any suitable situation in which fall protection is desired.

In various embodiments, the user is attached to a shuttle which provides integral energy absorption during a potential ejection event. During normal use, the shuttle allows smooth travel about the work platform. In various embodiments, the fall protection system is integrated with an anti-fatigue (e.g., foam) mat that can be trimmed to fit properly in the work platform and to maintain a flush surface in the work platform.

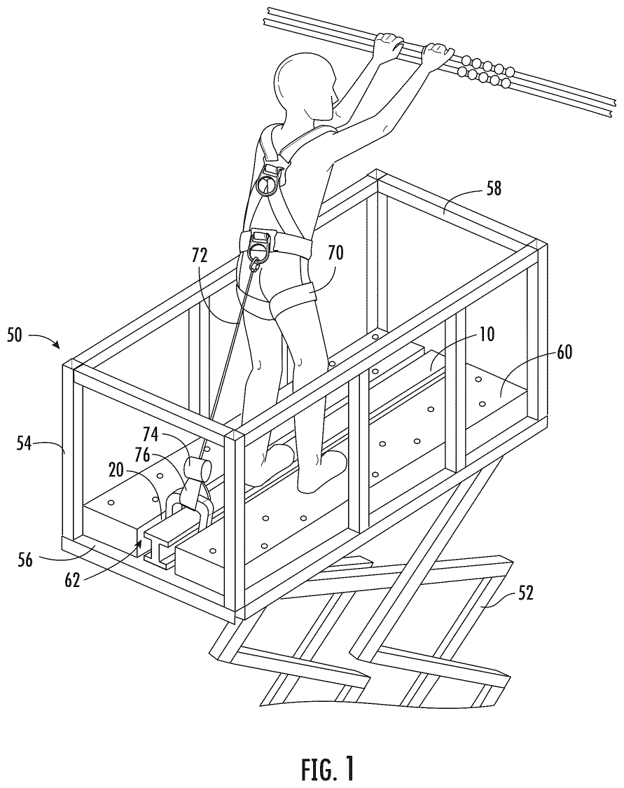

Referring now to FIGS. 1-6C, a fall protection system is illustrated in accordance with example embodiments of the present disclosure. An example scissor lift is illustrated in FIG. 1 having a fall protection system of embodiments of the present disclosure installed. The scissor lift 50 comprises a scissor-like lifting mechanism 52 supporting a work platform 54 (the base is omitted in FIG. 1). As illustrated in FIG. 1, the work platform 54 typically comprises a generally horizontal planar floor 56, a guardrail 58 around the perimeter of the work platform 54, and a mat 60 for cushioning and anti-slip functionality.

The fall protection system of FIGS. 1-6C comprises an elongated rail 10 and a movable shuttle 20 selectively engaged with the rail 10. As illustrated, in various embodiments the rail 10 is securely mountable to a surface, such as the floor 56 of the scissor lift 50. Although not illustrated, the rail may be secured to the surface using any suitable mechanism or method, such as bolting, welding, etc. In various embodiments, when mounted the rail 10 is substantially horizontal. In various other embodiments (not illustrated), the rail can be mounted in other suitable orientations. For example, the rail may be mounted on a side wall of a bucket of a MEWP in a skewed fashion, such that the rail is parallel to a vertical plane. In such embodiments in which the rail is not mounted on a surface upon which a user stands, a conventional mat would typically be used rather than the mat 60 described herein.

In various embodiments, the rail 10 comprises an elongated top flange 12, an elongated bottom flange 14 substantially parallel to the top flange 12, and an elongated web 16 therebetween that is substantially perpendicular to the top flange 12 and the bottom flange 14. In this regard, in various embodiments the rail is an I-beam.

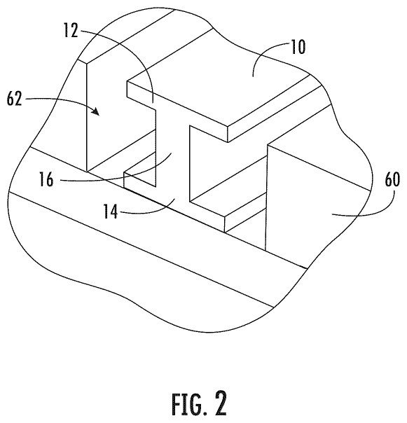

As seen in FIGS. 1 and 2, the rail 10 is typically mounted in an elongated gap 62 defined in the mat 60. In various embodiments, the gap 62 may be defined in along the entire length of the mat 60 such that the mat 60 is divided into two portions. In various embodiments, the gap 62 may be defined in the center of the mat 60 such that the mat 60 is divided into two equal portions. In various embodiments, the mat 60 is constructed of any suitable durable, comfortable material, such as polyurethane or non-Newtonian foam. In various embodiments, the height of the rail 10 and the height of the mat 60 are selected such that the top surface of the top flange 12 of the rail 10 is substantially even with the top surface of the mat 60.

In various embodiments, the shuttle 20 is selectively engaged with the rail 10, such that the shuttle 20 is slidable back and forth along the rail during normal use. However, when a user begins to fall, the shuttle, pivots, binds up, and does not slide as described further below. In various embodiments, the shuttle 20 comprises a main body and an attachment point 26 projecting upward from the main body. As seen in FIG. 1, a user wears a harness 70 that has a connecting device 72 (e.g., cable or nylon strap) attached thereto. The connecting device 72 typically extends and retracts from a self-retracting device 74, which in turn is attached to the attachment point 26 of the shuttle 20 via an attachment mechanism 76 (e.g., loop, carabiner, etc.). In this regard, the user is secured to the shuttle 20 which is engaged with the rail 10.

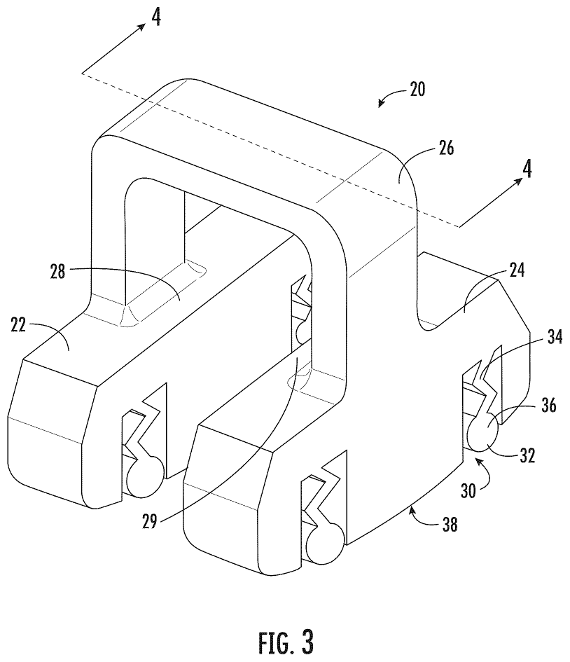

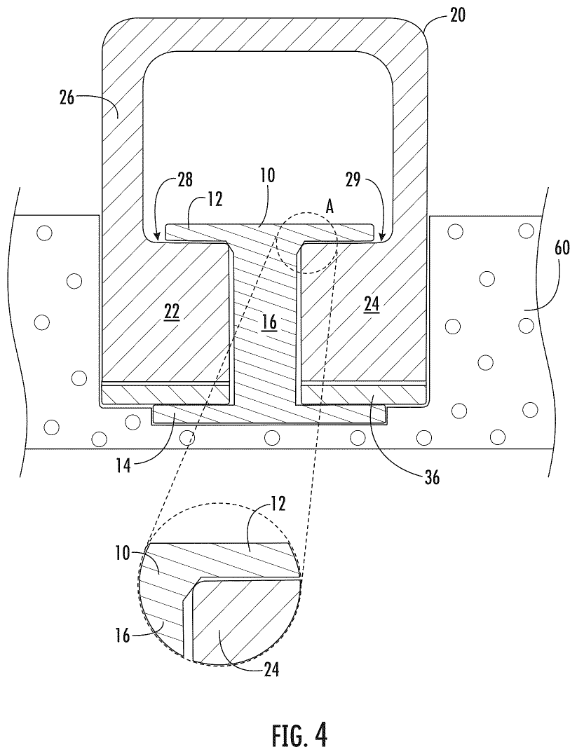

As best seen in FIG. 3, the main body of the shuttle 20 comprises a first main body portion 22 and an opposing second main body portion 24, and the attachment point 26 comprises an arch connecting the first main body portion 22 and the second main body portion 24. The first main body portion 22 and the second main body portion 24 are thereby separated by a space. The shuttle 20 is engaged with the rail 10 by sliding the shuttle 20 onto either one of the ends of the rail 10 such that the first main body portion 22 is on one side of the web 16 and the second main body portion 24 is on the other side of the web 16, as seen in FIG. 4.

In various embodiments, a medial portion 28 of the top surface of the first main body portion 22 is left open where the attachment point 26 meets the first main body portion 22 and a medial portion 29 of the top surface of the second main body portion 24 is left open where the attachment point 26 meets the second main body portion 24. It is these medial portion 28, 29 that enable, respectively, the first and second main body portions 22, 24 to engage with the rail 10 as described herein.

As seen in FIG. 4, when the shuttle 20 is engaged with the rail 10, a portion of the first main body 22 portion is sandwiched between the top flange 12 and the bottom flange 14 of the rail 10 on a first side of the web 16 and a portion of the second main body portion 24 is sandwiched between the top flange 12 and the bottom flange 14 of the rail 10 on an opposing second side of the web 16, and the arch of the attachment point 26 passes over the top flange 12 of the rail 10. A small gap is present between the top surface of each of the first and second main body portions 22, 24 and the underside of the top flange 12 of the rail 10.

When so engaged, the shuttle 20 can only be removed from the rail 10 by sliding the shuttle 20 off an end of the rail 10. Typically, a scissor lift has a short perimeter wall (not illustrated) around the floor of the work platform that helps, e.g., to prevent tools from sliding off the work platform. Such a perimeter wall blocks both ends of the rail such that the shuttle cannot slide off the rail. In such embodiments, the shuttle is engaged with the rail before the rail is mounted to the work platform as the perimeter wall would prevent the shuttle from sliding onto the rail after the rail has been mounted to the work platform. In some embodiments (not illustrated), a lid, cover, or the like may be used to cover one or both ends of the rail to prevent the shuttle from sliding off the rail during use. Such embodiments may be necessary when access doors in the basket are coincident with the rail, which could allow the shuttle to slide off the rail and exit the platform without such a lid, cover, or the like.

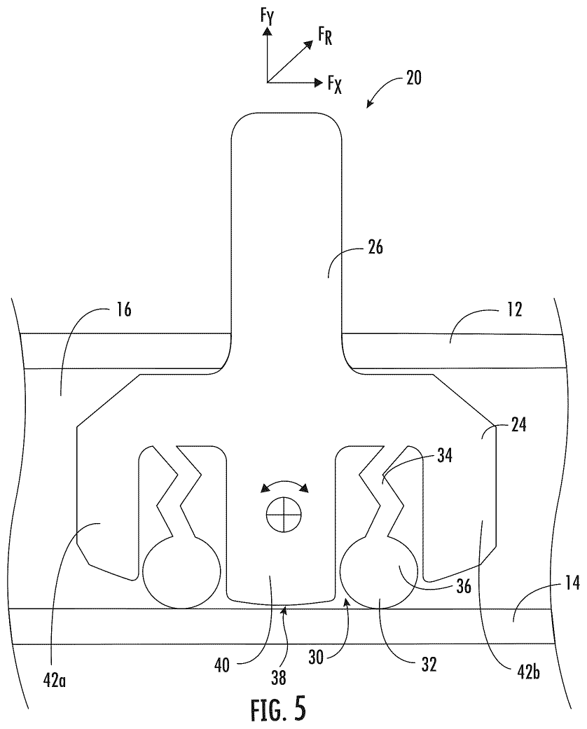

FIG. 5 is a side view of the shuttle 20 in which the second main body portion 24 is illustrated in more detail. In various embodiments, the first main body portion 22 is a mirror image of the second main body portion 24 and therefore has the same structure and features as described herein relative to the second main body portion 24. As best seen in FIG. 5, the second main body portion 24 has a bottom surface 38 that is generally convex (i.e., curved upward at the ends). In this regard, a first end portion 42a and a second end portion 42b of the second main body portion 24 are further away from the bottom flange 14 of the rail 10 than is a center portion 40 of the second main body portion 24 when the shuttle 20 is selectively engaged with the rail 10 and not pivoted (the pivoting of the shuttle is described further below). A gap 30 is formed between the first end portion 42a and the center portion 40 and between the second end portion 42b and the center portion 40.

As illustrated, the second main body portion 24 comprises two compressible or collapsible members 32, each positioned in a respective gap 30 between the center portion 40 and a respective one of the end portions 42a, 42b. That is, one of the compressible members 32 is adjacent the first end portion 42a of the second main body portion 24 and the other of the compressible members 32 is adjacent the second end portion 42b of the second main body portion 24. The two compressible members 32 project downward such that a proximal end of each compressible member 32 is integral with or affixed to the second main body portion 24 and a distal end of each compressible member 32 is in contact with the bottom flange 14 of the rail 10 when the shuttle 20 is selectively engaged with the rail 10 and not pivoted. In various embodiments, as seen in FIG. 5, when the shuttle 20 is selectively engaged with the rail 10 and not pivoted, only the distal end of each compressible member 32 is in contact with the bottom flange 14 of the rail 10 such that the shuttle 20 is supported by and “rides on” the four compressible members (two on each main body portion).

In the illustrated embodiment, each of the compressible members 32 comprise a collapsible stem 34 with a proximal end attached to or integral with the respective main body portion and a distal end 36 that is in contact with the bottom flange of the rail when the shuttle is selectively engaged with the rail and not pivoted. In the illustrated embodiment, the distal end 36 of each of the compressible members 32 is generally cylindrical and static (i.e., the distal end 36 does not rotate, spin, etc.). In various embodiments, the distal end of each of the compressible members may comprise, for example, a rotatable wheel or a spherical end shape.

In the illustrated embodiment, the collapsible stem 34 of each compressible member 32 has a zig-zag shape. In various embodiments, the thickness and shape (i.e., angles, number of segments, length of each segment) of the zig-zag collapsible stem 34 is carefully selected to enable the collapsible stem to collapse when a predetermined amount of pressure is applied to the compressible member 32 when the shuttle 20 is pivoted (as described further below). In various embodiments, the compressible member 32 may have any suitable design, shape, size, or material. For example, the compressible members may comprise compressible springs instead of collapsible stems.

In the illustrated embodiment, the entirety of the shuttle 20 (i.e., the attachment point 26 and the first and second main body portions 22, 24 (including the compressible members 32) are monolithic (i.e., constructed as a single unitary component). For example, the shuttle 20 may be constructed of aluminum and formed by casting. In other embodiments (not illustrated), the shuttle may be constructed of multiple separate components joined together.

When a user is attached to the shuttle 20 via a connecting device 72 or the like and the user moves (either purposefully and relatively slowly during normal use or suddenly and relatively quickly during an ejection), a force is applied by the connecting device 72 to the attachment point 26 of the shuttle 20. As illustrated in FIG. 5, such force will have an X axis (i.e., horizontal) component F_{X} and a Y axis (i.e., vertical) component F_{Y}, which together cause a resultant force F_{R}.

When the user moves during normal use such that the user has moved to the extent of the connecting device and needs to move further, the shuttle 20 will move along the longitudinal axis of the rail 10 to allow the user to move. The shuttle 20 may move in a first direction (e.g., right to left in FIG. 5) along the rail 10 or in a second direction opposite the first direction (e.g., left to right in FIG. 5) along the rail 10. The user's movement applies a force to the attachment point 26 of the shuttle 20.

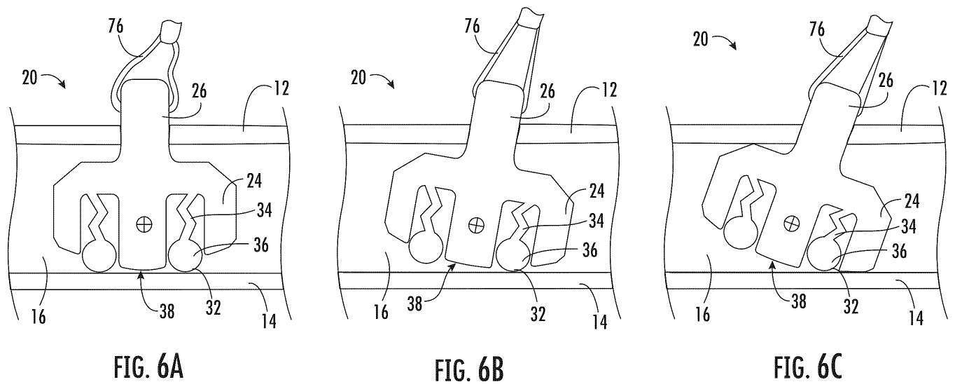

If the X axis component of the force applied to the attachment point 26 of the shuttle 20 is greater than a first threshold (i.e., sufficient to overcome friction) but less than a second threshold (i.e., not enough to cause the shuttle 20 to pivot), then the shuttle 20 will move in the direction of the force applied by the user. Because the shuttle 20 is not pivoting, the shuttle 20 will continue to be supported by and “ride on” the four compressible members (two on each main body portion) as it moves move in the direction of the force applied by the user. This is illustrated in FIG. 6A.

If the X axis component of the force applied to the attachment point 26 of the shuttle 20 is greater than the second threshold, such as would occur if a user ejects over, the shuttle 20 will begin to pivot. As the shuttle 20 begins to pivot, the compressible members 32 on each main body portion closer to the end to which the shuttle 20 is pivoting will begin to compress or collapse. This is illustrated in FIG. 6B. The collapsing of the compressible members 32 on each main body portion closer to the end to which the shuttle 20 is pivoting, along with the greater distance between the first end portion 42a and the second end portion 42b and the bottom flange 14 of the rail 10, allows the shuttle 20 to pivot.

As the shuttle 20 continues to pivot in the direction that the user is falling, the compressible members 32 will compress or collapse further, allowing the shuttle 20 to pivot even more. This pivoting of the shuttle 20 causes the first main body portion 22 and the second main body portion 24 to bind up between the top flange 12 and the bottom flange 14 of the rail 10. This is illustrated in FIG. 6C. The binding up of the first main body portion 22 and the second main body portion 24 between the top flange 12 and the bottom flange 14 of the rail 10 prevents any further movement of the shuttle 20 in the direction that the user is falling, thereby preventing the user from being ejected from the work platform 54.

Various embodiments of the present disclosure provide a fall protection system and method of fall prevention that is simple and inexpensive to construct and install, easy to operate, and provides excellent fall protection.

While the description above provides an example fall protection system, it is noted that the scope of the present disclosure is not limited to the description above. In some examples, an example fall protection system in accordance with the present disclosure may be in other forms. In some examples, an example fall protection system may comprise one or more additional and/or alternative elements, and/or may be structured differently than that illustrated in FIGS. 1-6C.

While various embodiments in accordance with the principles disclosed herein have been shown and described above, modifications thereof may be made by one skilled in the art without departing from the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present disclosure. Furthermore, any advantages and features described above may relate to specific embodiments but shall not limit the application of such issued claims to processes and structures accomplishing any or all of the above advantages or having any or all of the above features.

In addition, the section headings used herein are provided for consistency with the suggestions under 37 C.F.R. § 1.77 or to otherwise provide organizational cues. These headings shall not limit or characterize the disclosure set out in any claims that may issue from this disclosure. For instance, a description of a technology in the “Background” is not to be construed as an admission that certain technology is prior art to any disclosure in this disclosure. Neither is the “Summary” to be considered as a limiting characterization of the disclosure set forth in issued claims. Furthermore, any reference in this disclosure to “disclosure” or “embodiment” in the singular should not be used to argue that there is only a single point of novelty in this disclosure. Multiple embodiments of the present disclosure may be set forth according to the limitations of the multiple claims issuing from this disclosure, and such claims accordingly define the disclosure, and their equivalents, which are protected thereby. In all instances, the scope of the claims shall be considered on their own merits in light of this disclosure but should not be constrained by the headings set forth herein.

Also, systems, subsystems, apparatuses, techniques, and methods described and illustrated in the various embodiments as discrete or separate may be combined or integrated with other systems, modules, techniques, or methods without departing from the scope of the present disclosure. Other devices or components shown or discussed as coupled to, or in communication with, each other may be indirectly coupled through some intermediate device or component, whether electrically, mechanically, or otherwise. Other examples of changes, substitutions, and alterations are ascertainable by one skilled in the art and could be made without departing from the scope disclosed herein.

Many modifications and other embodiments of the disclosure set forth herein will come to mind to one skilled in the art to which these embodiments pertain having the benefit of teachings presented in the foregoing descriptions and the associated figures. Although the figures only show certain components of the apparatuses and systems described herein, various other components may be used in conjunction with the components and structures disclosed herein. Therefore, it is to be understood that the disclosure is not to be limited to the specific embodiments disclosed and that modifications and other embodiments are intended to be included within the scope of the appended claims. For example, the various elements or components may be combined, rearranged, or integrated in another system or certain features may be omitted or not implemented. Moreover, the steps in any method described above may not necessarily occur in the order depicted in the accompanying drawings, and in some cases one or more of the steps depicted may occur substantially simultaneously, or additional steps may be involved. Although specific terms are employed herein, they are used in a generic and descriptive sense only and not for purposes of limitation.

What is claimed is:

1. A fall protection system comprising:
an elongated rail adapted to be mounted to a surface, the rail comprising an elongated top flange, an elongated bottom flange substantially parallel to the top flange, and an elongated web therebetween that is substantially perpendicular to the top flange and the bottom flange; and
a shuttle selectively engaged with the rail, the shuttle comprising a main body and an attachment point projecting upward from the main body, the attachment point adapted to have a connecting device directly or indirectly attached thereto;
wherein the shuttle is configured to be selectively movable along the rail in a first direction along a longitudinal axis of the rail when a force applied to the attachment point of the shuttle has a first direction component that is greater than a first threshold and less than a second threshold;
wherein the shuttle is configured to be selectively movable along the rail in a second direction along the longitudinal axis of the rail opposite the first direction when a force applied to the attachment point of the shuttle has a second direction component that is greater than the first threshold and less than the second threshold;
wherein the shuttle is configured to pivot in the first direction such that at least a portion of the main body of the shuttle binds up between the top flange of the rail and the bottom flange of the rail so that the shuttle does not move in the first direction when a force applied to the attachment point of the shuttle has a first direction component that is greater than the second threshold; and
wherein the shuttle is configured to pivot in the second direction such that at least a portion of the main body of the shuttle binds up between the top flange of the rail and the bottom flange of the rail so that the shuttle does not move in the second direction when a force applied to the attachment point of the shuttle has a second direction component that is greater than the second threshold.

2. The fall protection system of claim 1, wherein the main body of the shuttle comprises a first main body portion and an opposing second main body portion; and
wherein the attachment point comprises an arch connecting the first main body portion and the second main body portion.

3. The fall protection system of claim 2, wherein, when the shuttle is selectively engaged with the rail, at least a portion of the first main body portion is sandwiched between the top flange of the rail and the bottom flange of the rail on a first side of the web, at least a portion of the second main body portion is sandwiched between the top flange of the rail and the bottom flange of the rail on an opposing second side of the web, and the arch of the attachment point passes over the top flange of the rail.

4. The fall protection system of claim 3, wherein the first main body portion has a bottom surface that is generally convex such that opposing first and second end portions of the first main body portion are further away from the bottom flange of the rail than a center portion of the first main body portion when the shuttle is selectively engaged with the rail and not pivoted; and
wherein the second main body portion has a bottom surface that is generally convex such that opposing first and second end portions of the second main body portion are further away from the bottom flange of the rail than a center portion of the second main body portion when the shuttle is selectively engaged with the rail and not pivoted.

5. The fall protection system of claim 4, wherein the first main body portion comprises a first compressible member adjacent the first end portion of the first main body portion and projecting downward and in contact with the bottom flange of the rail when the shuttle is selectively engaged with the rail and not pivoted;
wherein the first main body portion comprises a second compressible member adjacent the second end portion of the first main body portion and projecting downward and in contact with the bottom flange of the rail when the shuttle is selectively engaged with the rail and not pivoted;
wherein the second main body portion comprises a first compressible member adjacent the first end portion of the second main body portion and projecting downward and in contact with the bottom flange of the rail when the shuttle is selectively engaged with the rail and not pivoted;
wherein the second main body portion comprises a second compressible member adjacent the second end portion of the second main body portion projecting downward and in contact with the bottom flange of the rail when the shuttle is selectively engaged with the rail and not pivoted; and
wherein, when the shuttle is selectively engaged with the rail and not pivoted, only the first compressible member of the first main body portion, the second compressible member of the first main body portion, the first compressible member of the second main body portion, and the second compressible member of the second main body portion are in contact with the bottom flange of the rail.

6. The fall protection system of claim 5, wherein, when a force applied to the attachment point of the shuttle has a first direction component that is greater than the second threshold, the first compressible member of the first main body portion at least partly compresses and the first compressible member of the second main body portion at least partly compresses such that the shuttle pivots in the first direction and at least a portion of the main body of the shuttle binds up between the top flange of the rail and the bottom flange of the rail; and
wherein, when a force applied to the attachment point of the shuttle has a second direction component that is greater than the second threshold, the second compressible member of the first main body portion at least partly compresses and the second compressible member of the second main body portion at least partly compresses such that the shuttle pivots in the second direction and at least a portion of the main body of the shuttle binds up between the top flange of the rail and the bottom flange of the rail.

7. The fall protection system of claim 5, wherein the first compressible member of the first main body portion, the second compressible member of the first main body portion, the first compressible member of the second main body portion, and the second compressible member of the second main body portion each comprise a collapsible stem with a proximal end attached to or integral with the respective main body portion and a distal end that is in contact with the bottom flange of the rail when the shuttle is selectively engaged with the rail and not pivoted.

8. The fall protection system of claim 7, wherein the collapsible stem of the first compressible member of the first main body portion, the second compressible member of the first main body portion, the first compressible member of the second main body portion, and the second compressible member of the second main body portion each have a zig-zag shape.

9. The fall protection system of claim 7, wherein, when a force is applied to the attachment point of the shuttle that has a first direction component that is greater than the second threshold, the first compressible member of the first main body portion and the first compressible member of the second main body portion both at least partly compress to allow the shuttle to pivot in the first direction; and
wherein, when a force is applied to the attachment point of the shuttle that has a second direction component that is greater than the second threshold, the second compressible member of the first main body portion and the second compressible member of the second main body portion both at least partly compress to allow the shuttle to pivot in the second direction.

10. The fall protection system of claim 1, further comprising a mat having a first portion on a first side of the rail and a second portion on a second side of the rail with the rail in a gap therebetween such that a top surface of the top flange of the rail is substantially even with a top surface of the first portion of the mat and a top surface of the second portion of the mat.

11. A method of fall protection, the method comprising:
mounting an elongated rail to a surface, the rail comprising an elongated top flange, an elongated bottom flange substantially parallel to the top flange, and an elongated web therebetween that is substantially perpendicular to the top flange and the bottom flange;
engaging a shuttle selectively with the rail, the shuttle comprising a main body and an attachment point projecting upward from the main body, the attachment point adapted to have a connecting device directly or indirectly attached thereto; and
attaching a distal end of a connecting device to the attachment point of the shuttle, the connecting device having a proximal end attached to a harness worn by a user;
wherein the shuttle is configured to be selectively movable along the rail in a first direction along a longitudinal axis of the rail when the user applies a force to the attachment point of the shuttle has a first direction component that is greater than a first threshold and less than a second threshold;
wherein the shuttle is configured to be selectively movable along the rail in a second direction along the longitudinal axis of the rail opposite the first direction when the user applies a force to the attachment point of the shuttle has a second direction component that is greater than the first threshold and less than the second threshold;
wherein the shuttle is configured to pivot in the first direction such that at least a portion of the main body of the shuttle binds up between the top flange of the rail and the bottom flange of the rail so that the shuttle does not move in the first direction when the user applies a force to the attachment point of the shuttle has a first direction component that is greater than the second threshold; and
wherein the shuttle is configured to pivot in the second direction such that at least a portion of the main body of the shuttle binds up between the top flange of the rail and the bottom flange of the rail so that the shuttle does not move in the second direction when the user applies a force to the attachment point of the shuttle has a second direction component that is greater than the second threshold.

12. The method of claim 11, wherein the main body of the shuttle comprises a first main body portion and an opposing second main body portion; and
wherein the attachment point comprises an arch connecting the first main body portion and the second main body portion.

13. The method of claim 12, wherein, when the shuttle is selectively engaged with the rail, at least a portion of the first main body portion is sandwiched between the top flange of the rail and the bottom flange of the rail on a first side of the web, at least a portion of the second main body portion is sandwiched between the top flange of the rail and the bottom flange of the rail on an opposing second side of the web, and the arch of the attachment point passes over the top flange of the rail.

14. The method of claim 13, wherein the first main body portion has a bottom surface that is generally convex such that opposing first and second end portions of the first main body portion are further away from the bottom flange of the rail than a center portion of the first main body portion when the shuttle is selectively engaged with the rail and not pivoted; and
wherein the second main body portion has a bottom surface that is generally convex such that opposing first and second end portions of the second main body portion are further away from the bottom flange of the rail than a center portion of the second main body portion when the shuttle is selectively engaged with the rail and not pivoted.

15. The method of claim 14, wherein the first main body portion comprises a first compressible member adjacent the first end portion of the first main body portion and projecting downward and in contact with the bottom flange of the rail when the shuttle is selectively engaged with the rail and not pivoted;
wherein the first main body portion comprises a second compressible member adjacent the second end portion of the first main body portion and projecting downward and in contact with the bottom flange of the rail when the shuttle is selectively engaged with the rail and not pivoted;
wherein the second main body portion comprises a first compressible member adjacent the first end portion of the second main body portion and projecting downward and in contact with the bottom flange of the rail when the shuttle is selectively engaged with the rail and not pivoted;
wherein the second main body portion comprises a second compressible member adjacent the second end portion of the second main body portion projecting downward and in contact with the bottom flange of the rail when the shuttle is selectively engaged with the rail and not pivoted; and
wherein, when the shuttle is selectively engaged with the rail and not pivoted, only the first compressible member of the first main body portion, the second compressible member of the first main body portion, the first compressible member of the second main body portion, and the second compressible member of the second main body portion are in contact with the bottom flange of the rail.

16. The method of claim 15, wherein, when the user applies a force to the attachment point of the shuttle that has a first direction component that is greater than the second threshold, the first compressible member of the first main body portion at least partly compresses and the first compressible member of the second main body portion at least partly compresses such that the shuttle pivots in the first direction and at least a portion of the main body of the shuttle binds up between the top flange of the rail and the bottom flange of the rail; and
wherein, when the user applies a force to the attachment point of the shuttle that has a second direction component that is greater than the second threshold, the second compressible member of the first main body portion at least partly compresses and the second compressible member of the second main body portion at least partly compresses such that the shuttle pivots in the second direction and at least a portion of the main body of the shuttle binds up between the top flange of the rail and the bottom flange of the rail.

17. The method of claim 15, wherein the first compressible member of the first main body portion, the second compressible member of the first main body portion, the first compressible member of the second main body portion, and the second compressible member of the second main body portion each comprise a collapsible stem with a proximal end attached to or integral with the respective main body portion and a distal end that is in contact with the bottom flange of the rail when the shuttle is selectively engaged with the rail and not pivoted.

18. The method of claim 17, wherein the collapsible stem of the first compressible member of the first main body portion, the second compressible member of the first main body portion, the first compressible member of the second main body portion, and the second compressible member of the second main body portion each have a zig-zag shape.

19. The method of claim 17, wherein, when the user applies a force to the attachment point of the shuttle that has a first direction component that is greater than the second threshold, the first compressible member of the first main body portion and the first compressible member of the second main body portion both at least partly compress to allow the shuttle to pivot in the first direction; and
wherein, when the user applies a force to the attachment point of the shuttle that has a second direction component that is greater than the second threshold, the second compressible member of the first main body portion and the second compressible member of the second main body portion both at least partly compress to allow the shuttle to pivot in the second direction.

20. The method of claim 11, further comprising a mat having a first portion on a first side of the rail and a second portion on a second side of the rail with the rail in a gap therebetween such that a top surface of the top flange of the rail is substantially even with a top surface of the first portion of the mat and a top surface of the second portion of the mat.
